(19) United States
(12) Patent Application Publication
(10) Pub. No.: US 2018/0319278 A1
(43) Pub. Date: Nov. 8, 2018

(54) Tandem Axle With Disconnect Coast

(71) Applicant: Dana Heavy Vehicle Systems Group, LLC, Maumee, OH (US)

(72) Inventors: Mark A. Davis, Kalamazoo, MI (US); Steven G. Slesinski, Ann Arbor, MI (US); George A. Willford, Waterville, OH (US)

(21) Appl. No.: 15/968,779

(22) Filed: May 2, 2018

Related U.S. Application Data
(60) Provisional application No. 62/500,304, filed on May 2, 2017.

(51) Int. Cl. B60K 23/08; B60K 17/36; F16H 48/05; F16H 48/08

(52) U.S. Cl. CPC B60K 23/0808; F16H 48/08; F16H 48/05; B60K 17/36

(57) ABSTRACT

Provided herein in a method of disconnecting and connecting a tandem axle system, the method including the steps of: providing a tandem axle system including a primary clutch in driving engagement with a prime mover, an inter-axle differential and clutch assembly including an inter-axle differential and an inter-axle differential lock in selective driving engagement with the primary clutch, a forward axle assembly having a disconnect assembly, a rear axle assembly having a disconnect assembly, and a control system in communication with the inter-axle differential lock, the differential lock assembly, and the disconnect assemblies; disconnecting the disconnect assemblies of the forward and rear axle assemblies; engaging the inter-axle differential lock; disengaging the primary clutch; matching rotational speeds of the axle half shafts disconnect assemblies of the front and rear axle assemblies; connecting the disconnect assemblies of the forward and rear axle assemblies; and engaging the primary clutch.

### RELATED APPLICATION

The present application claims the benefit of U.S. Provisional Application No. 62/500,304, filed May 2, 2017, which is incorporated herein by reference in its entireties.

### BACKGROUND

Tandem axle assemblies are widely used on trucks and other load-carrying vehicles. The tandem axle assembly typically comprises a forward axle and a rear axle. Typically both axles are driven, in some cases only one axle is driven. The tandem axle assembly may be designated a 6x4 tandem axle assembly when the forward axle and the rear axle are drivingly engaged. The tandem axle assembly may be designated a 6x2 tandem axle assembly when either one of the forward axle and the rear axle is drivingly engaged.

If both axles are driven, it can be desirable to selectively disconnect one of the axles during times of low tractive requirements. This is preferable because during times of low tractive requirements, the axle that remains engaged can handle the tractive requirements of the vehicle by itself. It can be appreciated that when an axle is disconnected from the driveline, spinning and friction losses decrease, thus increasing the driveline efficiency. Currently, an automatic transmission is placed into neutral when a vehicle is coasting to reduce driveline losses and improve efficiency. However, greater driveline efficiency can be achieved by disconnecting the axle shafts of both the forward and rear tandem drive axles in coast condition and opening up the primary clutch.

### SUMMARY

Provided herein in a method of disconnecting and connecting a tandem axle system for a vehicle, the method including the steps of: providing a tandem axle system including a primary clutch in driving engagement with a prime mover; an inter-axle differential and clutch assembly including an inter-axle differential and an inter-axle differential lock in selective driving engagement with the primary clutch; a forward axle assembly including a differential assembly, a differential lock assembly, a disconnect assembly and two axle half shafts, wherein the disconnect assembly selectively connects the axle half shafts to the differential assembly; a rear axle assembly including a differential assembly, a disconnect assembly and two axle half shafts, wherein the disconnect assembly selectively connects the axle half shafts to the differential assembly; and a control system in communication with the inter-axle differential lock, the differential lock assembly, and the disconnect assemblies; disconnecting the disconnect assemblies of the forward and rear axle assemblies; engaging the inter-axle differential lock; disengaging the primary clutch; matching rotational speeds of the axle half shafts of the front and rear axle assemblies; connecting the disconnect assemblies of the forward and rear axle assemblies; and engaging the primary clutch.

### BRIEF DESCRIPTION OF THE DRAWINGS

The above, as well as other advantages of the present embodiments, will become readily apparent to those skilled in the art from the following detailed description when considered in the light of the accompanying drawings in which:

FIG. 1 is a schematic view of a preferred embodiment of a tandem axle system; and

FIG. 2 is a schematic view of a preferred embodiment of a driveline including the tandem axle system of FIG. 1.

### DETAILED DESCRIPTION OF THE PREFERRED EMBODIMENTS

It is to be understood that the present embodiments may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless expressly stated otherwise.

The embodiments relate to a method for limiting damage to a tandem axle system. The tandem axle system has at least two axle assemblies wherein one of the axle assemblies can be selectively engaged/disengaged. Particularly, the tandem axle system can be as disclosed in U.S. Pat. No. 8,523,738 and U.S. Pat. No. 8,911,321 hereby incorporated by reference. The above-referenced U.S. Pat. No. 8,523,738 and U.S. Pat. No. 8,911,321 disclose exemplary embodiments of a tandem axle system. However, it is understood the axle system may include fewer or more assemblies or components or have various configuration.

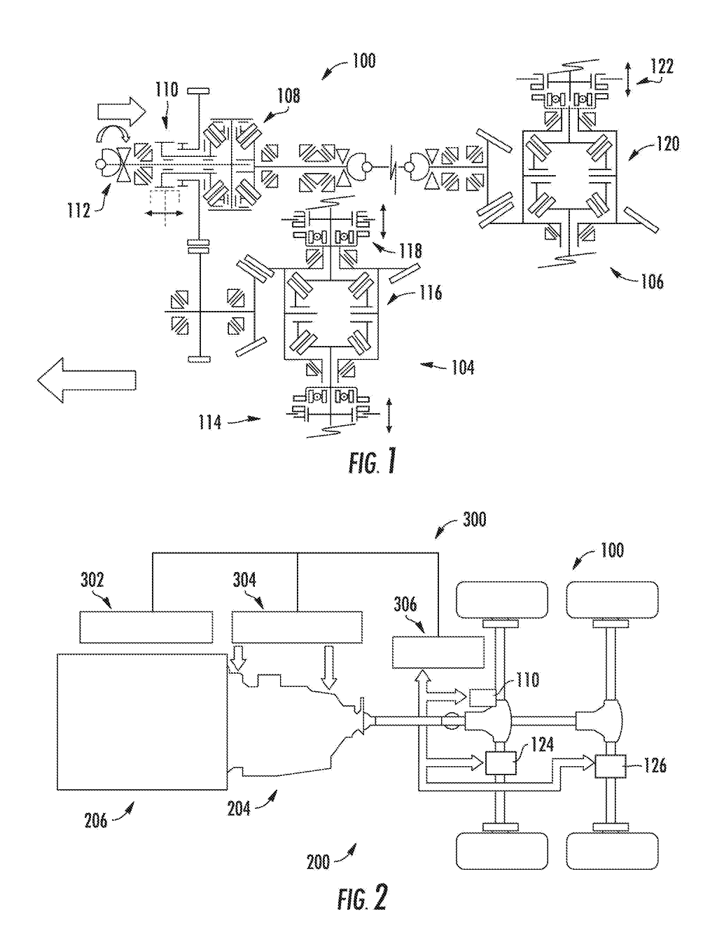

FIG. 1 illustrates one preferred embodiment of a tandem axle system 100. The tandem axle system 100 includes an inter-axle differential and clutching assembly 102, a forward axle assembly 104, and a rear axle assembly 106. The forward axle assembly 104 and the rear axle assembly 106 are in selective driving engagement with the inter-axle differential and clutching assembly 102.

Rotational energy is provided to the tandem axle system 100 through an input shaft 112 that is rotated by an internal combustion engine (not shown) or other source of rotational power or prime mover. A primary clutch is in driving engagement with the prime mover; and in selective driving engagement with the inter-axle differential and clutching assembly 102.

The inter-axle differential and clutching assembly 102 includes an inter-axle differential (IAD) 108 and an inter-axle differential lock 110. The IAD 108 is employed to split the input shaft 112 torque between the forward axle assembly 104 and the rear axle assembly 106.

In some embodiments, the IAD 108 includes at least two side gears and at least two pinion gears, with the side gears and pinion gears being in driving engagement with one another. The side gears and pinion gears are located within an IAD carrier.

A vehicle operator or control system 300 can engage and disengage the IAD lock 110 that overrides or disables the IAD 108. In one embodiment, the IAD lock 110 is a sliding dog clutch that is activated using a pneumatic actuator.

In some embodiments, the forward axle assembly 104 includes a differential assembly 116, a differential lock assembly 118 and a disconnect assembly 114 as depicted in FIG. 1. The disconnect assembly 114 selectively connects the differential assembly 116 to axle half shafts (not shown) of the forward axle assembly 104.

In some embodiments, the rear axle assembly 106 includes a differential assembly 120 and a disconnect assembly 122 as depicted in FIG. 1. The disconnect assembly 122 selectively connects the differential assembly 120 to axle half shafts (not shown) of the rear axle assembly 106.

In some embodiments, the disconnect assemblies 114, 122 are positioned on one axle shaft of the each of the axle assemblies 104, 106, as shown in FIG. 2, and include a disconnect/reconnect clutch and an actuator 124, 126. The actuator 124, 126 can be, but is not limited to, a pneumatic two-position actuator to operate the clutch.

In some embodiments, one axle shaft has an axle disconnect/reconnect clutch similar in design to the differential lock clutch 118. The clutch can be operated by a pneumatic two-position actuator.

As illustrated in FIG. 2, the input shaft 112 of the tandem axle system 100 is part of a vehicle driveline 200. The tandem axle system 100 is drivingly connected to a transmission 204. In some embodiments, the transmission 204 is an automated manual transmission. The transmission 204 is drivingly connected to an engine 206 of a motor vehicle.

Additionally, the driveline 200 can include a control system 300. The control system 300 includes at least one controller and one or more sensors or a sensor array. The sensors can be intelligent sensors, self-validating sensors and smart sensors with embedded diagnostics. The controller is configured to receive signals and communicate with the sensors.

The one or more sensors are used to monitor performance of the driveline 200. The sensors can collect data from the driveline of the vehicle including, but not limited to, the torque and rotational speed of the axle half shafts. The speed of rotation and the torque are indicative of the speed of rotation and torque of the engine. In one embodiment, the sensors are mounted along the axle half shafts of the driveline 200, but can also be mounted elsewhere on the vehicle.

In one embodiment, the control system 300 includes additional discrete sensors beyond sensors already included in other components of the vehicle. In another embodiment, no additional sensors or sensed data relay systems are required beyond what are already included in the driveline 200.

The control system 300 can also include a vehicle communication datalink in communication with the sensors and the controller. The sensors generate signals that can be directly transmitted to the controller or transmitted via the datalink or a similar network. In one embodiment, the controller can be integrated into an existing controller system in the vehicle including, but not limited to, an engine controller, a transmission controller, etc. or can be a discrete unit included in the control system 300. The controller may communicate a vehicle communication datalink message (comm. link J1939 or the like) to other components of the driveline 200 including, but not limited to, the engine.

In one embodiment, the controller is an electrical control unit (ECU). The ECU herein can be configured with hardware alone, or to run software, that permits the ECU to send, receive, process and store data and to electrically communicate with sensors, other components of the driveline 200 or other ECUs in the vehicle.

Additionally, the controller can include a microprocessor. The microprocessor is capable of receiving signals, performing calculations based on those signals and storing data received from the sensors and/or programmed into the microprocessor.

The control system 300 allows an operator of a vehicle and/or the controller to control the tandem axle system 100.

In some embodiments, the control system 300 includes an engine control unit 302, a transmission control unit 304 and an axle control unit 306. The control units 302, 304, 306 are in electronic communication with each other and a central controller (not shown). The axle control unit 306 is in communication with the inter-axle differential lock 110, the differential lock 118 and the disconnect assemblies 114, 122.

Depending on the position of the inter-axle differential lock 110, an operational mode of the tandem axle system 100 is adjusted. In some embodiments, the tandem axle system 100 may be placed in a 6x2 mode of operation or a 6x4 mode of operation. In the 6x4 mode of operation, both the forward axle assembly 104 and the rear axle assembly 106 are drivingly engaged with the input shaft 112 of the tandem axle system 100 through the IAD 108. In the 6x2 mode of operation, only the rear axle assembly 106 is drivingly engaged with the input shaft 112 of the tandem axle system 100 through the IAD 108 being placed in a locked condition (i.e. the IAD lock 110 is engaged) and the front axle assembly 104 is disconnected at the disconnect assembly 114.

The tandem axle system 100 can have multiple configurations known in the art including, but not limited to, low entry forward, high entry forward, through shaft forward configurations (6x4) and single drive axle configurations (6x2). By disconnecting the driveline 200 from the tandem axle system 100 during coasting, efficiency is gained.

To reduce the frictional and rotational losses stemming for the tandem axle system 100, the tandem axle system 100 can be placed into a coast mode. This occurs by disconnecting the primary clutch of the driveline 200, disconnecting the forward and/or rear axle assemblies and locking the IAD 108.

In a coast mode of operation, the tandem axle system 100 first determines if a driveline disconnect opportunity exists. This determination can be made using the control system 300 which receives signals from the control units 302, 304, 306 and/or operator to signal that a disconnect opportunity exist. The signal can be sent from axle control unit 306, the engine control unit 302 and/or the transmission control unit 304 or another part of the vehicle.

The controller then sends a signal to the engine 206 to go to zero torque to float the driveline 200. Next the controller sends a signal to disconnect the forward and rear axles by disengaging the disconnect clutches of the disconnect assemblies 114, 122.

Next, the IAD 108 is locked using the inter-axle differential lock 110 allowing the engine 206 to spin down to an idle mode. Alternatively, the IAD 108 can be locked using the IAD lock 110 before the forward and rear axles are disconnected using the disconnect assemblies 114, 122. Once the idle mode has been reached, the main driveline clutch can then be disengaged, disconnecting the tandem axle system 100 from the remainder of the driveline 200.

To reconnect the driveline 200 to the tandem axle system 100, the controller determines that a driveline reconnect opportunity exists using logic or receive a disconnect signal from the control system 300 including, but not limited to, the engine control unit 302 and/or the transmission control unit 304.

Next, the rotational speed across the axle half shafts and the disconnect assemblies 114, 122 are matched. This can be accomplished by controlling the engine RPMs and matching the speed across the disconnect assemblies 114, 122 by monitoring the wheel speed by means of a wheel speed sensor or ABS wheel speed information.

Once the speeds are matched, the axle half shafts can be reconnected using the disconnect assemblies 114, 122 and the control of the engine 206 is given back to the operator of the vehicle for normal operation.

The tandem axle system 100 can provide additional efficiency by disconnecting the axle half shafts in drive by utilizing the same existing disconnect assemblies 114, 122 and driving with one axle. In this mode of operation, the axle half shafts of the forward axle assembly 104 or rear axle assembly 106 can be disconnected. The control system 300 receives additional information regarding the vehicle load, including information derived from other vehicle sensors, to determine if an axle assembly could be disconnected without exceeding the capacity of the remaining axle assembly.

To disconnect an axle assembly 104, 106, the control system 300 receives signals showing that the vehicle has accelerated to a predetermined cruise speed. In some embodiments, the cruise speed is the in the high transmission range of the transmission 204. Additionally, the controller receives data regarding the vehicle load. If the data shows the load is below a predetermined set limit, the driveline 200 can be floated (i.e. zero engine torque is provided). Next, the IAD 108 is locked using the IAD lock 110 and the either the forward axle assembly 104 or the rear axle assembly 106 is unlocked. Finally, the control system 300 returns engine control to the operator of the vehicle or other controller.

To reconnect the axle assembly 104, 106, the control system 300 receives signals showing that vehicle has slowed to a predetermined axle reconnect speed. In some embodiments, the axle reconnect speed is the low transmission range provided by the transmission 204. Next, the driveline 200 can be floated (i.e. zero engine torque is provided). Then the control system 300 reconnects the axle half shafts of the disconnected axle assembly 104, 106 using the disconnect assemblies 114, 122 and the IAD 108 is unlocked. Finally, the control system 300 returns throttle control to the operator of the vehicle or other controller.

In accordance with the provisions of the patent statutes, the present disclosure has been described in what is considered to represent its preferred embodiments. However, it should be noted that the invention can be practiced otherwise than as specifically illustrated and described without departing from its spirit or scope.

What is claimed:

1. A method of disconnecting and connecting a tandem axle system for a vehicle, the method comprising the steps of:
providing a tandem axle system comprising:
a primary clutch in driving engagement with a prime mover;
an inter-axle differential and clutch assembly comprising an inter-axle differential and an inter-axle differential lock in selective driving engagement with the primary clutch;
a forward axle assembly comprising a differential assembly, a differential lock assembly, a disconnect assembly and two axle half shafts, wherein the disconnect assembly selectively connects the axle half shafts to the differential assembly;
a rear axle assembly comprising a differential assembly, a disconnect assembly and two axle half shafts, wherein the disconnect assembly selectively connects the axle half shafts to the differential assembly; and
a control system in communication with the inter-axle differential lock, the differential lock assembly, and the disconnect assemblies;
disconnecting the disconnect assemblies of the forward and rear axle assemblies;
engaging the inter-axle differential lock;
disengaging the primary clutch;
matching rotational speeds of the axle half shafts and disconnect assemblies of the front and rear axle assemblies;
connecting the disconnect assemblies of the forward and rear axle assemblies; and
engaging the primary clutch.
